(19) United States
(12) Patent Application Publication
(10) Pub. No.: US 2009/0086277 A1
(43) Pub. Date: Apr. 2, 2009

(54) METHOD AND APPARATUS OF ADDING PAGES TO AN IMAGE DATA FILE TO BE SENT OVER A NETWORK

(75) Inventors: Alex Cheshire, St. Albans (GB); Martin Roantree, Brookmans Park (GB); Robert Dowell, Stantonbury (GB); Sahadevasangary Gajadevasangary, Stevenage (GB)

Correspondence Address: PILLSBURY WINTHROP SHAW PITTMAN, LLP;XEROX CORPORATION, P.O. BOX 10500, MCLEAN, VA, 22102, US

(73) Assignee: Xerox Corporation, Stamford, CT (US)

(21) Appl. No.: 11/864,425

(22) Filed: Sep. 28, 2007

(51) Int. Cl. G06F 3/12; H04N 1/00

(52) U.S. Cl. 358/402; 358/1.15; 358/400

(57) ABSTRACT

A method for sending an image data file over a network is herein described. In the method, the first device stores an image data file including a plurality of pages. The first device may receive the image data file from an access device via a network. The first device determines if the image data file has at least one tag. The at least one tag identifies a location for including at least one substitute or additional page within the plurality of pages of the image data file. The substitute or additional page(s) is scanned to generate image data comprising the substitute or additional page(s). The image data is then included at the location in the image data file identified by the tag. The image data file, with the substitute or additional page(s), is then sent from the first device to a second device via a network.

### BACKGROUND

1. Field

The present disclosure is generally related to sending an image data file over a network. More specifically, the present disclosure is related to sending an image data file comprising a plurality of pages from a first device to a second device, wherein at least one substitute or additional page of image data may be included in the image data file.

2. Background

When a user wishes to send a large document over a network wherein at least one page of the document is to be marked or written upon, the user usually must print the entire document in physical form, write on the required page(s), and then manually scan the entire document into a device to send the document to the required location. The physical document may then be saved, discarded or recycled. Each time a user prints an entire document to mark one or a few pages and discards the document, the user wastes paper, time, and energy (e.g., during printing and scanning). This may be particularly true for documents that are available electronically (e.g., word processing documents on a personal computer (PC) or scanned files that have been stored on a PC or sent in an e-mail).

Printing an entire document to mark a few pages may be cumbersome, especially when a document contains a large number of pages. Additionally, when a user scans a document, the image quality of the document may degrade due to a poor quality document feeding device (e.g., an automatic document feeder or ADF) or a poor quality scanning device.

### SUMMARY

One aspect provides a method for sending an image data file over a network. The method includes storing an image data file including a plurality of pages on a first device coupled to the network and determining if the image data file has at least one tag. The at least one tag identifies a location for including at least one substitute or additional page within the plurality of pages of the image data file. The method also includes scanning the at least one substitute or additional page to generate image data including the at least one substitute or additional page; including the image data with the at least one substitute or additional page in the image data file, and sending the image data file with the at least one substitute or additional page therein to a second device coupled to the network.

Another aspect provides a system for sending an image data file over a network, the system including a first device which is configured and arranged to send and receive the image data file comprising a plurality of pages over the network. The first device includes a driver. The driver is configured and arranged to determine the presence of at least one tag in the image data file. The at least one tag identifies a location for including at least one substitute or additional page of image data within the plurality of pages of the image data file. The driver is configured to include the at least one substitute or additional page in the image data file prior to the first device sending the image data file to a second device coupled to the network.

In an embodiment, the first device scans the at least one substitute or additional page to generate image data including the at least one substitute or additional page, and the driver adds the at least one substitute or additional page to the identified location within the plurality of pages.

An additional aspect provides a method for adding or substituting at least one page to or in an image data file, wherein the image data file is to be sent from a first device to a second device over a network. The method includes accessing an image data file including a plurality of pages and adding at least one tag to the image data file. The at least one tag identifies a location for including at least one substitute or additional page within the plurality of pages of the image data file. The method also includes sending the image data file to the first device and scanning the at least one substitute or additional page to generate image data including the at least one substitute or additional page. The at least one substitute or additional page is included in the identified location of the plurality of pages of the image data file before sending the image data file over the network from the first device to the second device.

In an embodiment, the at least one tag of the above methods or system identifies at least one page to be printed.

In an embodiment, the first device and second device in the method or system may include facsimile devices. In an embodiment, the first device or second device may include a multi-function device.

In an embodiment, a method may include manually marking the at least one substitute or additional page.

Other features and advantages of the present disclosure will become apparent from the following detailed description, the accompanying drawings, and the appended claims.

### BRIEF DESCRIPTION OF THE DRAWINGS

FIG. 1 illustrates a system comprising devices sending and receiving image data files over communication network in accordance with an embodiment.

FIG. 2 illustrates a method of tagging a page within an image data file.

FIG. 3 illustrates a method of determining the presence of a tag within an image data file in accordance with an embodiment.

### DETAILED DESCRIPTION OF THE EMBODIMENT(S)

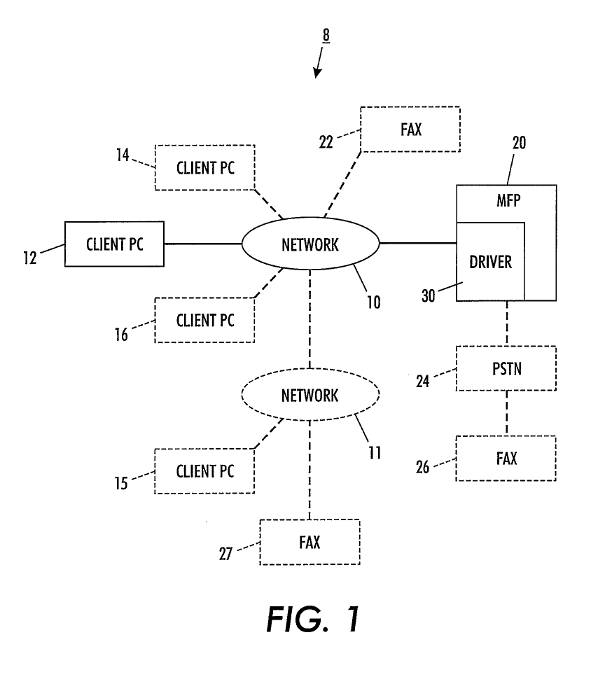

FIG. 1 illustrates a system 8 comprising devices sending and receiving image data files over communication network 10 in accordance with an embodiment. Communication network 10 connects or links at least an access device 12 and a first device 20. In an embodiment, a plurality of devices 12, 14, 16, 20, and 22 are connected on network 10. The communication network 10 may be a digital network such as a local area network (LAN), a wide area network (WAN), the Internet or Internet Protocol (IP) network, broadband networks (e.g., PSTN with broadband technology), Voice Over IP, WiFi network, or other networks or systems, or a combination of networks and/or systems. For example, network 10 may communicate with network 11, which has additional devices or machines such as client PC 15 or fax device 27 connected thereto, as shown in FIG. 1.

Access device 12 may enable a user to access an image data file and/or request sending of an image data file over the network 10. Access device 12 may be a workstation or client PC device, for example. In an embodiment, access device or client PC 12 may enable a user to send and receive electronic messages. As shown, any number of devices 14, 16 may be connected to network 10. In an embodiment, device 14 and 16 may be client PCs or workstations.

First device 20 is configured and arranged to send and receive an image data file comprising a plurality of pages over the network 10. In an embodiment, the first device 20 may be any known device capable of communicating over a network. In an embodiment, the first device 20 may be any known device capable of scanning and printing a page(s) of an image data file, and communicating the image data file over a network.

First device 20 may be a facsimile machine, terminal, or “fax” device, for example. Facsimile terminals, or “fax machines,” are widely used in home and office environments. A fax machine typically has the following basic components: (1) a processor for managing the transmission and receipt of faxed documents, (2) a scanner for scanning a document and converting it to a digital image file, (3) a printer for printing a received image file as a document, and (4) a user interface for enabling the user to operate the device and input data, such as from send destinations.

Faxing is a telecommunication technology used to transfer copies of documents, over a communication network, such as a telephone network, cell-phone system, computer network (e.g., LAN, WAN, Internet) or a combination of aspects thereof. A facsimile or fax may be any copy or reproduction of a document by faxing. The International Telecommunication Union Telecommunications Standardization Sector (ITU or ITU-T), based in Geneva, Switzerland, coordinates telecommunication standards and protocols, including facsimile transmission. For example, the ITU identifies the standards, characteristics, and operation for facsimile devices of Group 3 and Group 4 digital transmission. Group 3 (G3) fax technology is currently the most widely used type of facsimile transmission. In general, G3 fax technology uses digital modulation combined with amplitude and phase modulation of an analog signal (generated by modems). Typically data is compressed using digital compression methods and encoding is then used to communicate image data over analog telephone lines with a result of a reduced transmission time of less than one minute per page. Group 4 (G4) faxes are designed to operate over digital circuits; specifically, G4 operates on a 64 Kbps ISDN (Integrated Services Digital Network) B Channel. Unlike Group 3 faxes, the digital scan information is not converted into an analog signal, but, rather, transmitted digitally. Nonetheless, any Group or Class of facsimile transmission may be used with the above system.

Fax or facsimile machines disclosed herein are merely exemplary and embodiments of the disclosure may be practiced with other system having fax capabilities (e.g., a computer, a fax server/gateway, personal digital assistant (PDA), cell phone, etc.). In addition, in an embodiment, the fax machines or first device 20 may comprise or may be a part of another machine or device such as a multifunction printing device (MFP or MFD) that includes multiple capabilities such as printing, scanning, faxing, and/or copying. In an embodiment, first device 20 may comprise a PC, or other device for sending and receiving faxes. Other machines and devices may also be used as long as they are capable of handling electronic image data.

For example, some embodiments may contemplate use with computer based faxing (also referred to as desktop faxing, Internet faxing, “mail to fax,” “fax to mail,” or e-faxing). Computer based faxing involves using a fax server/gateway and an electronic mail/e-mail server on a network such as the Internet to convert between faxes and e-mail, for example, as disclosed in U.S. Pat. Nos. 6,020,980 and 6,424,266, which are herein incorporated by reference in their entirety. The fax server may have a directory or other means for correlating fax numbers and/or recipients with e-mail addresses. When a fax is received by the fax server, the fax server may generate an e-mail message to the receiver, including the image data of the facsimile. The image data of the facsimile may be embedded into the e-mail message itself or transferred as an electronic attachment to the e-mail message (e.g. attached in the form of a PDF or TIFF file).

The use of the faxing technology is also exemplary and embodiments of the disclosure may be practiced with other systems having the capabilities to handle electronic image data (e.g., a computer (PC), personal digital assistant (PDA), cell phone, etc.). In an embodiment, first device 20 may comprise a PC, PDA, cell phone, MFP, or other device for sending and receiving electronic image data. Other machines and devices may also be used as long as they are capable of handling electronic image data. For example, some embodiments may contemplate use with computer based transmission of data (such as “scan to e-mail” transmission). Thus, electronic image data may be sent using a server on a network such as the Internet to send the electronic image data to a recipient with an e-mail address. The image data may be embedded in an e-mail message, for example, and transferred electronically via a known network to a another device (e.g., second device 22 or 26, as will be further described) connected to the network. In an embodiment, the electronic image data may be sent to a file or to a file server or computer storage system (e.g., for archiving, organizing, or retrieval at a later time).

In an embodiment, first device 20 may send the image data file (e.g., to be faxed) to a PC device 14 or 16. In an embodiment, the first device 20 may be used to send the image data file to another or second device 22 or 26, for example. In an embodiment, at least one additional device 22 is connected or linked to network 10.

In an embodiment, a device 26 may be connected or linked to first device 20 through another network 24. For example, in one embodiment, network 24 may be a telephone network, such as a public switched telephone network (PSTN) or cell phone system, in which first device 20 sends an image data file to another device 26 using the network 24. In an embodiment, device 26 may be a facsimile or fax machine. As noted above, the use of a fax machine as device 26 is merely exemplary, and an embodiment of the disclosure may be practiced with other systems having fax capabilities, such as a computer, PDA, cell phone, or other machines or devices.

The image data file may be accessed by using access device 12. The image data file may be accessed using an application such as a word-processing application, e-mail application, or other known application that may be used on a client PC or access device.

In an embodiment, the image data file comprises a plurality of pages wherein a user is required to manually mark (e.g., sign one's signature using a writing instrument such as a pen) at least one page of the image data file. The system 8 of FIG. 1 is designed to accommodate such a need in that, when a user accesses and/or requests sending of an image data file using access device 12, the user may “tag” at least one page of the image data file. The tag is used to identify a location for including at least one substitute or additional page of image data within the plurality of pages of the image data file, as will be further described below. The user tags at least one page of the image data file and sends the image data file via network 10 to first device 20.

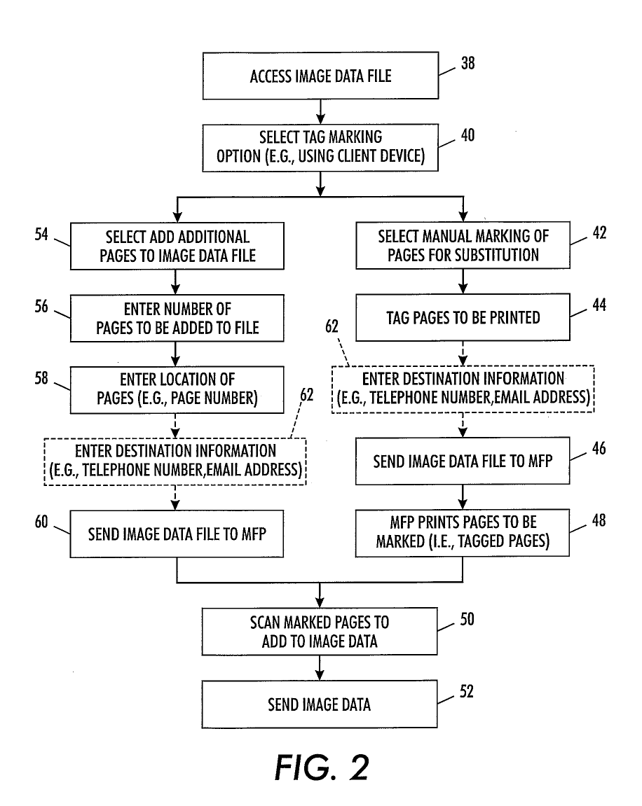

The first device 20 may store, manipulate, and send the image data file to the appropriate destination (e.g., a second device 22). In an embodiment, the first device 20 comprises at least a driver 30 configured and arranged to determine the presence of at least one tag in an image data file. After determining the presence of at least one tag, the driver 30 of first device 20 will allow a user to manipulate or include additional image data (e.g., at least one substitute or additional page) in the image data file. For example, when a user is required to manually mark or sign at least one page of a document, the user may tag the appropriate page, and, after marking or signing the page, add the page in the original location amongst the plurality of pages of the image data file. In an embodiment, at least one substitute or additional page may be included within a specified or previously identified location in the image data file, as further described with reference to FIG. 2.

FIG. 2 illustrates a method of tagging a page within an image data file. A user accesses an image data file 38 comprising a plurality of pages (e.g., using client PC or access device 12). The user selects the option to tag 40 at least one page of the image data file. In an embodiment, the user may select the option to manually tag or mark 42 (e.g., using an application or menu on device 12) at least one page of the plurality of pages in the image data file. For example, when a user needs to manually mark or sign a page(s) in a document, the user may manually tag or mark such page(s) in the image data file 44. At least one tag is inserted in the image data file to identify the location for including at least substitute page within the plurality of pages of the image data file. After tagging the page(s) to be marked, the image data file may be sent 46 to the first device 20. The driver 30 of the device 20 may then detect the tagged page(s) and print the page(s) 48 that were tagged by the user. After marking the page(s), the user scans the marked pages 50 using the first device 20. In an embodiment, the scanned data from the marked pages (referred to as substitute pages) is sequentially inserted into the original location amongst the plurality of pages in the image data file. After the tagged page(s) are scanned and inserted into the image data file, the user may send the image data file 52 from the first device 20 to the second device 22 using network 10.

In an embodiment, after the user selects the option to tag 40 at least one page of the image data file, the user may select the option of adding extra or additional pages to the image data file 54. The user may enter the number of pages to be added to the image data file 56, and/or the location for the page numbers to be included 58 in the image data file (e.g., the page number, before a page number, after a page number, etc.). At least one tag is inserted in the image data file to identify the location for including at least one additional page to be added to the plurality of pages of the image data file. After tagging the page(s) to be marked, the image data file may be sent 60 to the first device 20. The driver 30 of the device 20 may then detect the tag(s) in the image data file. In an embodiment, the user retrieves the image data file from the first device 20. The user then scans the least one additional page(s) 50 using the first device 20. In an embodiment, the at least one additional page(s) are inserted into the identified location amongst the plurality of pages in the image data file. After the additional page(s) are scanned and insert into the image data file, the user may send the image data file 52 from the first device 20 to the second device 22 using network 10.

In an embodiment, the user may choose to add additional pages and substitute pages in the image data file at the same time.

In an embodiment, the user accesses the “tag option” through a program or application, such as in a menu of a word processing application. For example, tagging a page may be an option in the print menu of a word processing program. In an embodiment, the tag option may be presented on a user interface. In an embodiment, the tag option (e.g., in the application) or user interface may allow the user to enter information for sending the image data file from the first device 20 to second device 22, for example.

In an embodiment, the user may be prompted to enter destination or address information related to second device 22. For example, in an embodiment, first device 20 may be a MFP and second device 22 may be a fax device. To send a fax from first device 20 to second device 22, the user may need to enter a telephone number or e-mail address 62 corresponding to the second device 22 (e.g., using the tag option or user interface available on access device 12).

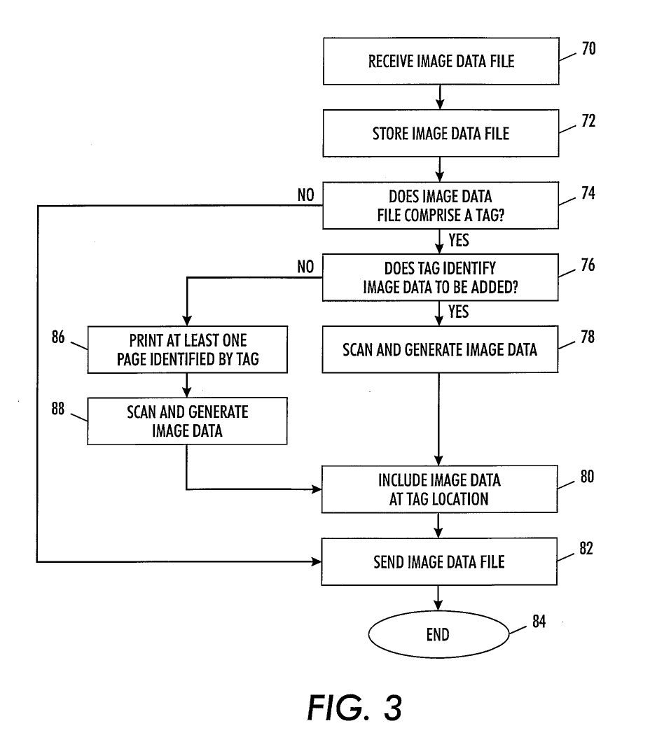

FIG. 3 illustrates a method of using first device 20 to determine the presence of a tag within an image data file in accordance with an embodiment. The driver 30 of the first device 20 may be configured and arranged to determine the presence of at least one tag in the image data file. Further, the driver 30 may be used to manipulate the image data file. An image data file is received 70 and stored 72 on first device 20. For example, the image data file may be sent from access device 12. The driver 30 of the device 20 then determines 74 if the image data file comprises at least one tag. If the image data file does not comprise a tag, the image data file is sent 82 from first device 20 to a second device such as device 22 (e.g., via network 10) and the process is complete 84.

If the image data file comprises a tag, the driver 30 of the first device 20 identifies if the tag indicates if a page of image data is to be substituted or added 76 to the image data file. If the tag indicates image data is to be added, the driver 30 or device 20 prompts a user to use device 20 to scan the page(s) to be added. The additional pages are then scanned and image data is generated 78 for the page(s). The scanned image data is then included 80 in the image data file (e.g., at the location identified by the tag). The image data file may be sent 82 to a second device such as device 22 (or any other similar device such as devices 12, 14; 15, or 16) and the process completed 84.

Referring back to the step of identifying the tag 76, if the tag does not identify that image data is to be added, the first device 20 and driver 30 determine that the tag indicates that a page is to be substituted. Thus, the device 20 prints the at least one page identified by the tag 86 for the user to manually mark or sign. After manually marking the printed page(s), the user scans the page(s) and image data is generated 88 corresponding to the page(s). The scanned image data is then included 80 in the image data file (e.g., at the location identified by the tag). The image data file is sent 82 from the first device 20 to a second device 22 such as device 22 (or any other similar device such as devices 12, 14, 15, or 16) over the network 10 and the process is completed 84.

Thus, the system 8 of FIG. 1 is designed such that a user may use access device 12 to communicate an image data file to the first device 20 via network. The first device 20 may be used to send the image data file to any one or more access devices 12, 14, 15, and 16 or devices 22, 26, and 27 on digital or analog networks (e.g., such as networks 10, 11, or 24). When sending the image data file to another device connected to a network, the image data file may be converted (if needed) as known in the art into analog or digital format, and compressed as necessary to send the image data file over the network. For example, in an embodiment, first device 20 sends image data file to device 26 over network 24. Network 24 may be a telephone or analog network such as a PSTN, for example. Device 26 may be a fax device or machine that is capable of receiving faxes using G3 fax technology, for example. As shown in FIG. 1, first device (MFP) 20 communicates with fax device 26 via an analog telephone network 24. Thus, first device 20 and driver 30 may be used to convert an image data file from digital format into analog format in order to transmit the image data file to fax device 26. The first device 20 may then send the image data file as described above with respect to FIG. 3 to the fax device 26.

The system and method as herein described is beneficial when a small number of pages in a large document need to be added or substituted into an image data file. For example, the image data file may be a document such as an insurance document that may require a user's signature or hand-written initials on several pages throughout the document.

As another example, a home loan application may have a signature page, and also require the applicant to supply additional documents, such as a recent tax return. The signature page could be tagged for substitution, with the user printing it, signing it, and scanning it back into the device for replacement of the unsigned pages in the original. Also, the additional page tag(s) may be used to locate the inclusion of a scanned additional document, such as the tax return.

Thus, the system and method wastes less paper as the user is not required to print the entire document and scan the entire document with the signed pages in the appropriate location. It also assists in reducing the amount of time spent (e.g., when a user has to for an entire document to print and then scan the entire time) by the user, as well as reducing costs (e.g., wasted paper). Additionally, documents or files that are secure remain secure in that by not being printed in its entirety, the document or file does not need to be destroyed. The system and method also is beneficial when sending an image data file from one device to another, such as when faxing a document. Additionally, the image quality of documents is improved, as only the scanned portion of the document is subject to the quality/performance of the printer, scanner, or ADF. Also, if the first device 20 is a multifunction machine such as an MFP, and has the ability to scan and fax in color (but not necessarily print in color), the system and method as herein described allows the user to use the color fax for all pages except those that scanned and added to the location identified by the tag.

While the principles of the disclosure have been made clear in the illustrative embodiments set forth above, it will be apparent to those skilled in the art that various modifications may be made to the structure, arrangement, proportion, elements, materials, and components used in the practice of the disclosure.

It will thus be seen that the features and advantages of this disclosure have been fully and effectively described. It will be realized, however, that the foregoing preferred specific embodiments have been shown and described for the purpose of illustrating the functional and structural principles of this disclosure and are subject to change without departure from such principles. Therefore, this disclosure includes all modifications encompassed within the spirit and scope of the following claims.

What is claimed is:

1. A method for sending an image data file over a network, the method comprising:
storing an image data file comprising a plurality of pages on a first device coupled to the network;
determining if the image data file comprises at least one tag, the at least one tag identifying a location for including at least one substitute or additional page within the plurality of pages of the image data file;
scanning the at least one substitute or additional page to generate image data comprising the at least one substitute or additional page;
including the image data comprising the at least one substitute or additional page in the image data file, and
sending the image data file with the at least one substitute or additional page therein to a second device coupled to the network.

2. A method according to claim 1, further comprising determining if the at least one tag identifies at least one page to be printed.

3. A method according to claim 2, further comprising printing the at least one page identified to be printed.

4. A method according claim 1, wherein the first device and second device comprise facsimile devices.

5. A system for sending an image data file over a network comprising:
a first device configured and arranged to send and receive the image data file comprising a plurality of pages over the network;
the first device comprising a driver, the driver configured and arranged to determine the presence of at least one tag in the image data file, the at least one tag identifying a location for including at least one substitute or additional page of image data within the plurality of pages of the image data file, and,
wherein, the driver is configured to include the at least one substitute or additional page in the image data file prior to the first device sending the image data file to a second device coupled to the network.

6. A system according to claim 5, wherein the first device and second device comprise a facsimile device.

7. A system according to claim 6, wherein the first device or second device comprise a multi-function printing device.

8. A system according to claim 5, further comprising a client device configured and arranged to send the image data file to the first device.

9. A system according to claim 8, wherein the second device comprises the client device.

10. A system according to claim 5, wherein the network comprises a LAN or WAN network.

11. A system according to claim 5, wherein the driver determines if the at least one tag identifies at least one page to be printed.

12. A system according to claim 11, wherein the first device prints the at least one identified page.

13. A system according to claim 5, wherein the first device scans the at least one substitute or additional page to generate image data comprising the at least one substitute or additional page, and, wherein the driver adds the at least one substitute or additional page to the identified location within the plurality of pages.

14. A method for adding or substituting at least one page to or in an image data file, the image data file to be sent from a first device to a second device over a network, the method comprising:
accessing an image data file comprising a plurality of pages;
adding at least one tag to the image data file, the at least one tag identifying a location for including at least one substitute or additional page within the plurality of pages of the image data file;
sending the image data file to the first device;
scanning the at least one substitute or additional page to generate image data comprising the at least one substitute or additional page, and
wherein the at least one substitute or additional page is included in the identified location of the plurality of pages of the image data file before sending the image data file over the network from the first device to the second device.

15. A method according to claim 14, further comprising printing the at least substitute or additional page with the at least one tag.

16. A method according to claim 15, further comprising manually marking the at least one substitute or additional page.
